(19) United States
(12) Patent Application Publication
(10) Pub. No.: US 2018/0167415 A1
(43) Pub. Date: Jun. 14, 2018

(54) System and Method for Simplifying Mandatory Access Control Policies

(71) Applicants: Faiz Khan, San Jose, CA (US); Muhammad Masoom Alam, Islamabad (PK)

(72) Inventors: Faiz Khan, San Jose, CA (US); Muhammad Masoom Alam, Islamabad (PK)

(73) Assignee: Wanclouds Inc., Santa Clara, CA (US)

(21) Appl. No.: 15/836,774

(22) Filed: Dec. 8, 2017

Related U.S. Application Data
(60) Provisional application No. 62/431,531, filed on Dec. 8, 2016.

(51) Int. Cl. H04L 29/06; H04L 12/24; G06F 21/60

(52) U.S. Cl. CPC H04L 63/20; H04L 63/10; H04W 12/08; G06F 21/604; H04L 41/0893

(57) ABSTRACT

This invention relates to a system and method for simplifying mandatory access control policies. A central dashboard provides a single location for managing policies across multiple environments. Management features and options include: high-level language interpretation, permission tracking, grouping, compliance monitoring, machine learning and analytics, and policy tracking.

### BACKGROUND

Mandatory Access Control (MAC) in Linux means that there is no super user and every subject (process, thread, etc.,) will have to comply with the defined policy. There are multiple flavours of MACs, chief among them are the SELinux and AppArmor.

Security-Enhanced Linux (SELinux) is a Linux kernel security module that provides a mechanism for supporting access control security policies. It is an implementation of a mandatory access control (MAC) mechanism. Though theoretically, it should work on any Linux distribution, SELinux works perfectly fine on Redhat based distributions such as CentOS, Fedora & Redhat. Thus, it is more focused on Redhat based distributions. SElinux has three basic features:
1) SElinux Modes: Enforcing, Permissive, Disabled
2) SElinux Policy: Strict, Targeted
Other policies are: Minimum, Standard, MLS, and Refpolicy.
3) SElinux Access Control Types: Type Enforcement (TE), Role-Based Access Control (RBAC), and Multi-Level Security (MLS)

AppArmor is also a Mandatory Access Control (MAC) system which is a kernel enhancement to confine programs to a limited set of resources. AppArmor security model is to bind access control attributes to programs rather than to users. AppArmor confinement is provided via profiles loaded into the kernel, typically on boot. AppArmor policies are called Profiles which can be in one of two modes: Enforcement and Complain.

A significant challenge in configuring SELinux, AppArmor, or similar policies is that they are error prone and present a very tedious job. These policies are currently very cumbersome, time-consuming to deploy, and hard to manage. There is no centralized utility today where you can build, deploy, and manage these MAC policies for your container and VM environment. There is no enforcement mechanism in place where you can actively monitor and enforce compliance.

### SUMMARY

This invention relates to a system and method for simplifying mandatory access control designed for Linux boxes, Virtual machines and services. The system provides a centralized utility for building, deploying, and managing MAC policies for container and VM environments, as well as an interface for active monitoring and enforcement of compliance.

The system can protect databases because policies can be created to restrict Read/Write access to mounted volumes while creating containers and applying customized policies on it. These policy modules have different access permissions associated with the mounted volumes. Any tampering with the database containers or the hosts are monitored.

The system protects the integrity of the hosts by running integrity checks—built on top of the Intel CIT boot time integrity and enhancing it to real time environment. The system creates visibility of the attack surface and provides alerts for changes in container policies and host changes.

The system provides initial assessment of the attack surface for containers and hosts by generating a report of the current state of the cluster or a single virtual machine.

The system enables compliance by utilizing uniform policies and active monitoring of the attack surface across different clouds and a user's own data centers.

The system contains the integrity of virtual machines.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a conceptual diagram illustrating actions that can be performed in an embodiment of the system.

FIG. 2 is a flow chart illustrating processes associated with adding a new host in an embodiment of the system.

FIG. 3 is a diagram illustrating the logical architecture of an embodiment of the system.

FIG. 4 is a diagram illustrating deployment configurations of an embodiment of the system.

FIG. 5 is an illustration showing an example dashboard in an embodiment of the system.

FIG. 6 is a diagram illustrating a user's example workflow in an embodiment of the system.

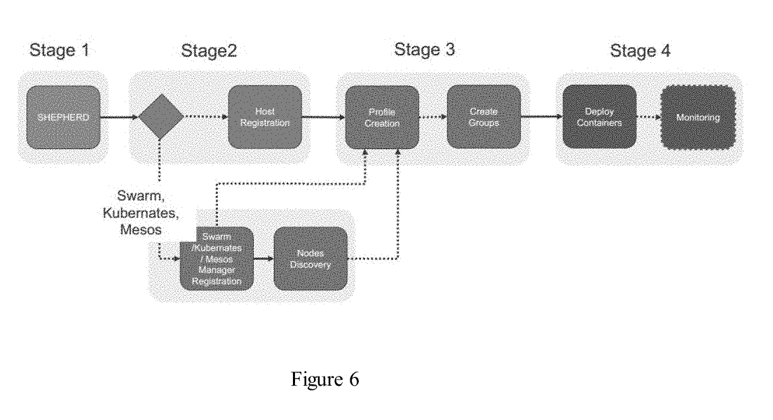

FIG. 7 is an illustration showing an example container grouping in an embodiment of the system.

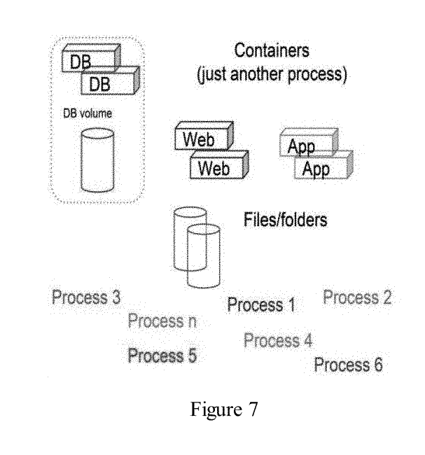

### DETAILED DESCRIPTION

This system is a completely agentless platform with no daemon installed on the VM or Linux Box. A user is able to configure, deploy and manage multiple policies in numerous VMs through well-defined APIs using this system. The system enables policy enforcement for containers across any private/public cloud or datacenter.

The term “services” as used in this document includes ordinary services such as Apache or Squid, as well as container services such as LXC, Docker, etc. This system provides extensive support for managing containers MAC policies, be it SELinux, AppArmor, or another policy provider.

The software process of this system are intended to run on computer hardware devices that are generally well-known in the art, and typically include at a minimum a processor, memory, permanent storage, network communications, and input and output devices.

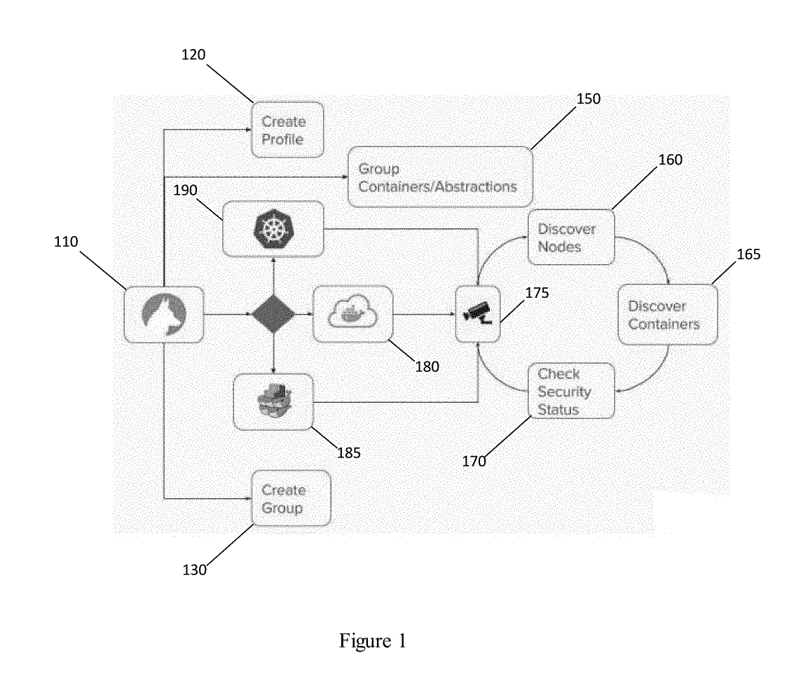

As illustrated in FIG. 1, MAC simplification system 110 is a collection of hardware devices and software processes configured to simplify the deployment, enforcement, management, monitoring, and compliance of mandatory ‘access control’ (MAC) policies for Linux based virtual machines and containers. MAC simplification system 110 allows a user to perform actions, including but not limited to Create Profile Action 120, Create Group Action 130, Group Containers/Abstractions Action 150, Security Actions 175, Access Dashboard Action 180, Management Action 190, and Add Host Action 185.

Create Profile Action 120 allows a user to create a profile, which saves the state of the system to permanent storage such as a database. The saved profile can later be accessed to quickly load desired settings and other information associated with the state of the system.

Create Group Action 130 allows a user to create a Group 370, which is described further below.

Group Containers/Abstractions Action 150 allows a user to modify groups created by the Create Group Action 130, by adding or removing containers or other abstractions.

Security Actions 175 allow a user to execute Discover Nodes Action 160, Discover Containers Action 165, and Check Security Status Action 170. Discover Nodes Action 160 allows a user to locate nodes that have not yet been added to containers or abstractions. Discover Containers Action 165 allows a user to locate containers, or groups of nodes. Check Security Status Action 170 allows a user to retrieve security status information for a node or container.

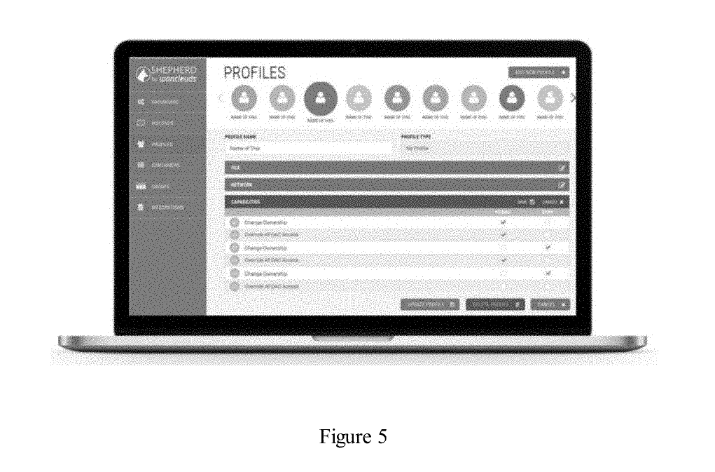

Access Dashboard Action 180 allows a user to access a dashboard interface, such as that illustrated in FIG. 5. From the dashboard, various configuration and deployment management actions can be performed.

Management Action 190 allows a user to perform a variety of individual tasks associated with the management of security policies.

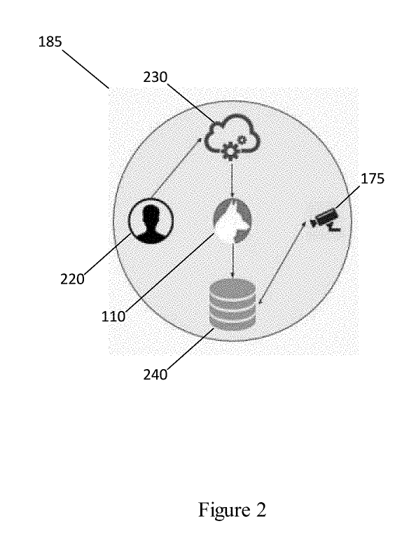

Add Host Action 185 is further illustrated in FIG. 2. User 220 accesses User Interface 230 to initiate Add Host Action 185. Once the action is initiated, MAC simplification system 110 executes Polling Process 240. Polling Process 240 is a software process that requests information from hosts using well-known protocols and procedure calls. Polling Process 240 invokes Security Actions 175 to acquire security information about the new host.

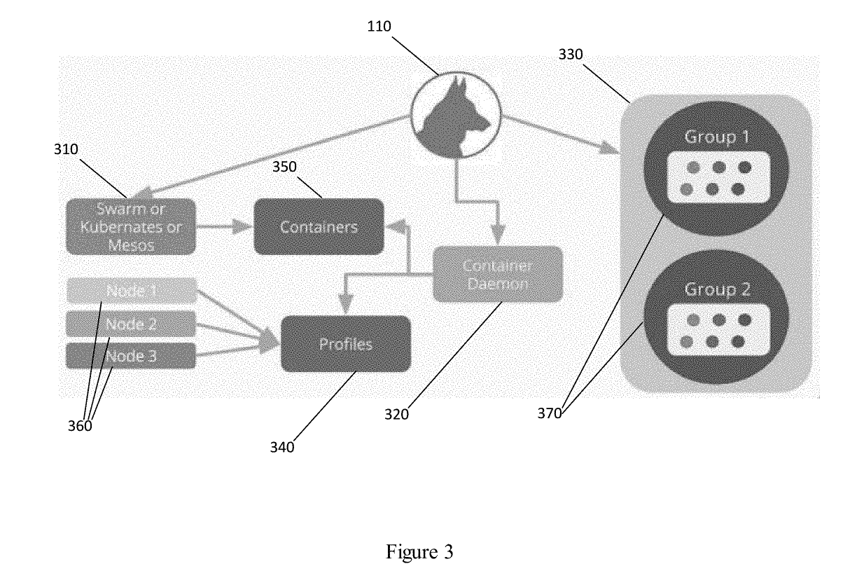

FIG. 3 illustrates the logical architecture of an embodiment of the system. MAC Simplification System 110 is composed of Swarm 310, Container Daemon 320, and Group Set 330. Swarm 310 is a collection of Containers 350. Container Daemon 320 is a software system that manages Containers 350 and Profiles 340. Profiles 340 is a collection of Nodes 360. Nodes 360 are individual devices whose MAC policies are managed by MAC Simplification System 110. Group Set 330 is a collection of Groups 370. Groups 370 which are single logical camps that represent a collection of containers running on different hosts. A user can then apply a MAC policy on a Group 370 irrespective of the host it is residing on.

The system provides kernel level security (SElinux, grsecurity etc). Processes such as containers running with root capabilities. Unconfined processes are considered to be a threat for a system. As an unconfined label can transition to almost any domain, the system makes sure to transfer any unconfined label to a confined domain. The system gives perimeter security through FWs. The system provides container image security (quarantined image). Host level processes, if not isolated from kubernetes abstractions processes leads to a security risk. If no policy is applied on the host then a compromised host would allow the attacker to have read/write access which can manipulate the whole security of the system/cluster, and the container will have open access to manipulate other containers. If a host has a unconfined processes or label running then it is vulnerable to attacks. The system makes sure that there is no unconfined process running.

The system allows isolation of processes, grouping of containers by image and by name, creating and applying security profile, integrity at run-time, integrity at rest with Intel CIT, VMs or bare-metal, can be deployed internally or externally.

Physical servers don't have the hypervisor overhead layer that is common to virtual machines (VMs). As such, running containers directly on bare metal (physical servers) should offer faster performance. But how much of a difference? As it turns out, there is quite a bit of difference. This typically provides 3× improvements in network latency. As long as Intel CIT solution is deployed with bare metals, monitoring will be enhanced by the system.

The system as embodied in FIG. 3 functions by incorporating the following features and processes:
1. Management of MAC policies from a single dashboard: This means enabling, disabling policy enforcement etc., that is the complete life cycle of MAC policies.
2. High level MAC policy statements: A high level language for describing the low level details of both AppArmor and SELinux. The high level statements make it very convenient for the tenant to create a MAC policy on the fly. Often one or more commands are responsible for managing an access control decision. For example, managing directory access means directory listing, getting inside a directory etc. All of these low level permissions are represented by a particular high level MAC statement such as “Directory Access”. Thus, a user of this system is not concerned about the details of underlying operating system for managing directory access.
3. Permission Tracking: Not only is configuring a MAC policy on a Linux machine a cumbersome job, but in an organization it can be very difficult to keep track of different permissions changes by administrators. For example, in a production environment, it is often required to maintain a log or journal of changing permissions. This system has super user access to a VM or system and it has direct access to the sensitive data. All users of this system should be audited in order to keep track of different permissions changes on the production system.
4. Grouping: Grouping is a high level concept associated with containers. Using this feature, containers running on different hosts can be grouped into a single logical camp. Thus a user can apply a MAC policy on a group irrespective of the host it is residing on. The Selinux MLS feature is used to reflect the grouping concept in this system.
5. Monitoring for Compliance: Similar to the way it is difficult to create and deploy MAC policies, gathering logs from individual machines and then analyzing them for possible violations adds more complexity to the problem. This system manages the MAC logs by alerting the tenant of possible violations, plus storing the logs if needed by the tenant for a specified amount of time. It also supports various Compliances such as HIPPA, PCI compliance by providing different reports of respective compliances. For example, 164.312(a)(2)(i) of the HIPPA compliance writes as “Have you assigned a unique name and/or number for identifying and tracking user identity? (R)”. This system generates a report based on this specific requirement containing records of user activity via this system to a target VM.
6. Machine Learning & Analytics: This system provides extensive machine learning features such as process behaviour profiling. This system is able to profile a process behavior and in such cases as allowing a right in the wrong time frame, this system can alert the tenant of a possible change in the behaviour of a specific process or container. As enabling logs on a system is an expensive activity with regards to the resource, this system occasionally enables logs, applies machine learning algorithms such as FP-Growth to find patterns and then switches off logging. For critical VMs or containers, logs are enabled more frequently.
7. Policy Tracking: This system takes the hash of each MAC policy before deployment on the target machine. This hash is verified after a specified amount of time. A tenant can set a minimum time depending on how critical a service or VM is. Further, this system also provides versioning of the policies, thus old policies are stored in the Shepherd centralized repository and can be accessed and applied any time.

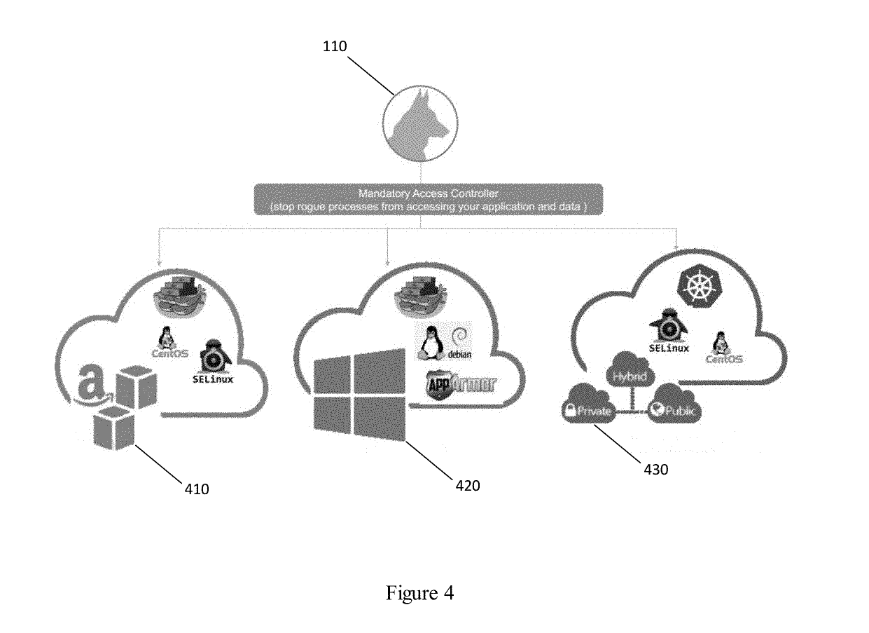

FIG. 4 illustrates example deployment configurations of an embodiment of the system. The system can be deployed in Cloud Configuration 410, which is a Software as a Service (SaaS) controller in the cloud with multi-tenancy. It can be deployed in Private Configuration 420, which is on-premises deployment. It can also be deployed in Hybrid Configuration 430, which is a private controller for a specific tenant in the cloud.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A mandatory access control policy management system comprising:
a processor;
a computer readable storage media that comprises instructions stored in the computer readable storage media that are executable with the processor, the instructions comprising:
instructions for allowing a user to manage mandatory access control policies for multiple containers from a dashboard;
instructions for allowing a user to manage mandatory access control policies by utilizing a high-level language.

2. The mandatory access control policy management system of claim 1, further comprising:
instructions to record and track all permission changes made.

3. The mandatory access control policy management system of claim 1, further comprising:
instructions for allowing a user to group multiple containers into a single logical unit.

4. The mandatory access control policy management system of claim 1, further comprising:
instructions for alerting a user of any detected violation of a mandatory access control policy.

5. The mandatory access control policy management system of claim 1, further comprising:
instructions for recording a profile of a container's typical behavior;
instructions for alerting a user when a container deviates from its typical behavior.

6. The mandatory access control policy management system of claim 1, further comprising:
instructions for recording a hash of a mandatory access control policy before the mandatory access control policy is deployed;
instructions for verifying the hash of a mandatory access control policy once a specified period of time has passed after the mandatory access control policy has been deployed.

7. A method of managing mandatory access control policies comprising:
displaying with a display device a mandatory access control policy management dashboard;
in response to receipt from an input device of a high-level mandatory access control policy management command:
interpreting and executing the command.
